(19) United States
(12) Patent Application Publication
(10) Pub. No.: US 2019/0021208 A1
(43) Pub. Date: Jan. 24, 2019

(54) TOWED AGRICULTURAL IMPLEMENT

(71) Applicant: Horsch Maschinen GmbH, Schwandorf (DE)

(72) Inventor: Michael Horsch, Schwandorf (DE)

(73) Assignee: Horsch Maschinen GmbH, Schwandorf (DE)

(21) Appl. No.: 16/043,882

(22) Filed: Jul. 24, 2018

(30) Foreign Application Priority Data
Jul. 24, 2017 (DE) 102017116637.8

(51) Int. Cl. A01B 63/16; A01B 63/22

(52) U.S. Cl. CPC A01B 63/163; A01B 63/22

(57) ABSTRACT

A towed agricultural implement comprising a central frame to which laterally extending side frames are connected for supporting a plurality of ground working tools and in which each side frame is supported above the ground by a swiveling wheel which freely pivots when moving forward but which can be locked in perpendicular alignment to the side frame when moving in reverse.

### CROSS-REFERENCE TO RELATED APPLICATIONS

This application claims priority from German application No. DE 10 2017 116 637.8, filed Jul. 24, 2017 the contents of which are incorporated herein by reference.

### FIELD OF THE INVENTION

This invention concerns a towed agricultural implement.

### BACKGROUND OF THE INVENTION

A towed implement with work tools arranged on a frame, a drawbar and depth guide wheels arranged laterally next to the drawbar and in front of the work tools on the frame and movable in an upright plane for guiding the frame and the work tools in height relative to the ground is shown in EP 2 840 880 A1.

Another implement can be found in EP 1 935 224 A1. It comprises a central frame with a drawbar wherein pivoting side frames are arranged on the sides of the central frame. At least one guide element rolling on arable land is attached to the central frame and/or next to the drawbar, and a depth guide wheel rolling on arable land is attached to the front region of each side frame.

It is an object of the invention to create a towed agricultural implement that avoids the disadvantages of conventional techniques. The invention is based in particular on the task of creating a way of producing an implement comprising guide elements with a large contact area and at the same time of achieving a compact frame construction for the depth guide wheels.

Advantageous designs and applications of the invention are explained in more detail in the following description with partial reference to the figures.

### SUMMARY OF THE INVENTION

In accordance with general aspects of the invention, a towed agricultural implement is provided with a central frame having a connecting device, for example in the form of a drawbar or a drawbar eye or the like, wherein side frames are arranged laterally to the central frame so as to pivot about axes running parallel to the direction of travel or obliquely in space, wherein at least one guide element rolling on arable land is mounted on the central frame and/or next to the connecting device, and at least one depth guide wheel rolling on arable land is mounted on the side frame in its front region respectively. The side frames can be attached directly to the central frame or to an intermediate frame or to a swivel frame or the like, which intermediate frame or swivel frame can in turn be connected to the central frame. The depth guide wheels assigned to the side frames in their front regions can also be arranged in front of or to the side of the side frames. In particular, the depth guide wheels are arranged in front of the work tools assigned to the side frame, whereby the depth guide wheels can also be mounted laterally or between work tools.

The guide element is pivoted about a first axis of rotation, and the depth guide wheel is pivoted about a second axis of rotation. As the guide element has a large contact area or a large diameter according to the invention, and the depth guide wheel is compactly mounted on the side frames, the first axis of rotation and the second axis of rotation have an axial offset relative to one another. In order to compensate for this axial offset of the guide elements and the depth guide wheels, it is provided to pivotally mount the depth guide wheels with a swiveling holder about an upright pivot axis wherein the depth guide wheels are mounted to the swiveling holder via a bearing having a second pivot axis and the second pivot axis of the depth guide wheels lies in the plane or adjacent to the plane of the pivot axis and wherein the at least one guide element is mounted to the central frame with a bearing having a first pivot axis wherein the pivot axes have an axial offset relative to one another.

The first axis of rotation and the second axis of rotation may have a horizontal orientation oriented transversely to the direction of travel. They can also be oriented transversely to the direction of travel at an angle or run obliquely in space and transversely to the direction of travel. The first axis of rotation and the second axis of rotation run parallel in a straight travel of the agricultural implement and have different angles and/or orientations with respect to the direction of travel during cornering. In particular, the depth guide wheels arranged on the respective side frames also have different orientations relative to each other during cornering whereby these orientations are compensated accordingly by the arrangement of the depth guide wheels pivotable about an upright pivot axis and/or this orientation is achieved in each case by the pivotability.

To prevent the working depth from being altered by a pivoting movement of the depth guide wheels and to ensure the smoothest possible running, an adjacent arrangement of the second axis of rotation and/or the axis of rotation of the depth guide wheels in relation to the pivot axis is provided. In particular, the pivot axis and the second axis of rotation intersect. The following applies: The greater the distance between the second axis of rotation and the pivot axis, the greater the height difference caused by a pivoting motion of the depth guide wheels.

The smoothness of the depth guide wheels during forward travel can also be improved by the pivot axis of the depth guide wheels being aligned and/or oriented from the rear/top to front/bottom, wherein this alignment includes in particular an angle greater than 15° and less than 75°. This means that the pivot axis of the depth guide wheels is inclined relative to a vertical axis, whereby this inclination can be between 15° and 75° in particular.

In order not to obtain a transverse position of the depth guide wheels during both forward travel and reverse travel, it is also provided that the depth guide wheels which can be pivoted about an upright pivot axis can be freely pivoted during forward travel of the implement and that the depth guide wheels which can be pivoted about an upright pivot axis are brought into an at least largely parallel alignment to the at least one guide element during reverse travel by means of a limiting element. A parallel alignment to the direction of travel would also be conceivable, whereby the alignment of the guide element corresponds in particular to the direction of travel.

A large contact area of the guide elements and/or the depth guide wheels can be achieved in particular by the use of crawler tracks or crawler belts, whereby these are used in particular as guide elements due to the increased weight available. However, wheels or rollers with a correspondingly large diameter could also be used. The diameter of the wheels or rollers and/or the length and width of the crawler tracks can in turn be adapted to the respective existing weight.

The swivel angle can also be limited in a forward movement in at least one direction of rotation, whereby this swivel angle is dependent on the offset between the first horizontal axis of rotation and the second horizontal axis of rotation. The swivel angle is particularly selected so that the implement can be steered without the depth guide wheels skidding across the ground.

In order to obtain a simple design of the limiting element, it is designed as an actuator, e.g. in the form of a linear drive. The actuator is in particular an electrically, pneumatically or hydraulically operated actuator. According to an exemplary embodiment, the actuator can be a hydraulically operated actuator which can be controlled via an electrically controllable hydraulic valve. The hydraulic valve can be a conventional solenoid valve, for example.

The limiting element can be designed both as an actuator that can move freely in two directions and as an actuator that can be locked in two directions, e.g. as a double-acting cylinder. Depending on the respective steering angle during a reverse travel, the respective side or the respective steering angle of the depth guide wheels could be limited by the actuator and/or the double-acting cylinder, and the actuator and/or the double-acting cylinder could also bring the depth guide wheel into an at least approximately parallel alignment with respect to the guide element.

A compact and simple design as well as a simplified depth adjustment of the implement can be achieved in particular by having height-adjustable depth guide wheels. A linear drive and/or a spindle drive, for example, can be integrated into the swiveling holder. In particular, it would be conceivable that the linear drive and/or the spindle drive would also form the swiveling holder or the bearing of the swiveling holder. The swiveling holder can also be integrated in a height-adjustable mounting frame attached to the side frame.

A sensor may be fitted to the implement to determine forward or reverse travel. For example, the sensor can be used to detect a rotary movement of the depth guide wheels and/or the guide elements. A sensor can also be used to determine whether the implement is moving along a left or right curve. A corresponding radius of curvature or a corresponding steering angle or swivel angle can also be measured using a sensor. Depending on the travel movements of the implement determined by means of the sensor(s), the limiting element can also be controlled, whereby a hydraulic and/or electrical and/or pneumatic control or a combination of these can be provided on the implement.

It should be noted that in the sense of the invention the term “control” is understood as a generic term for any kind of influence on the actuator or the limiting element including by a programmable controller, whereby the term “control” also includes a “regulation”, since a regulation is a control with feedback of the controlled variable. The control can therefore also be designed as a regulator, in particular for regulating the actuator.

In addition, the limiting element could also be operated manually by an operator or a corresponding valve could be operated by an operator.

In order to further improve the steering characteristics of the implement, it can also be provided that the guide element can also be steered and/or that the guide element is also attached to the central frame so that it can pivot about an upright axis. The guide element and the depth guide wheels also have different steering angles during cornering. An actuator and/or linear element can also be provided to adapt the steering movements of the guide elements.

### BRIEF DESCRIPTION OF THE DRAWINGS

In the following, design examples will explain the invention and its advantages in more detail using the attached figures. The proportions of the individual elements to each other in the figures do not always correspond to the real proportions since some shapes are simplified and others are enlarged in relation to other elements for better illustration. Shown are:

FIG. 1A is a perspective view of a towed agricultural implement.

FIG. 1B is a side view of the towed agricultural implement according to FIG. 1A.

FIGS. 2A and 2B are schematic plan views of a towed agricultural implement wherein the swivel angles of the depth guide wheels associated with a radius of curvature are displayed in each case.

FIGS. 3A to 3D are embodiments of a depth guide wheel for use in a towed agricultural implement, in a perspective view (FIG. 3A), in a sectional perspective view (FIG. 3B), in a side view from the left with wheel (FIG. 3C), and in a side view from the right without wheel (FIG. 3D).

### DETAILED DESCRIPTION

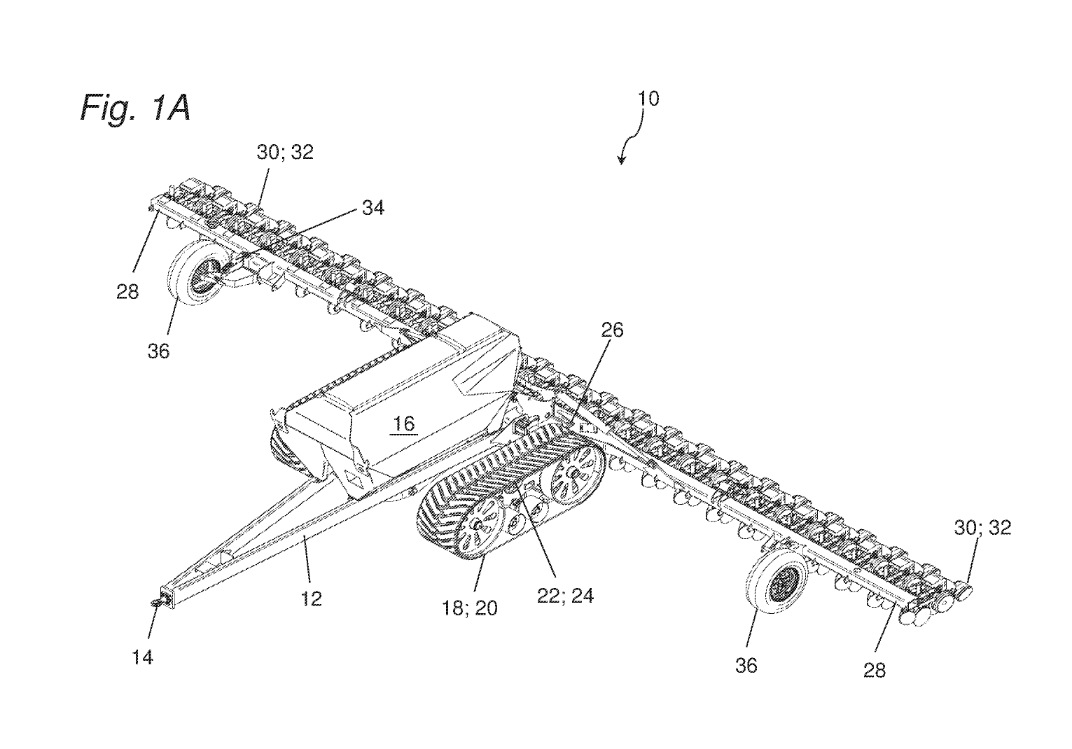

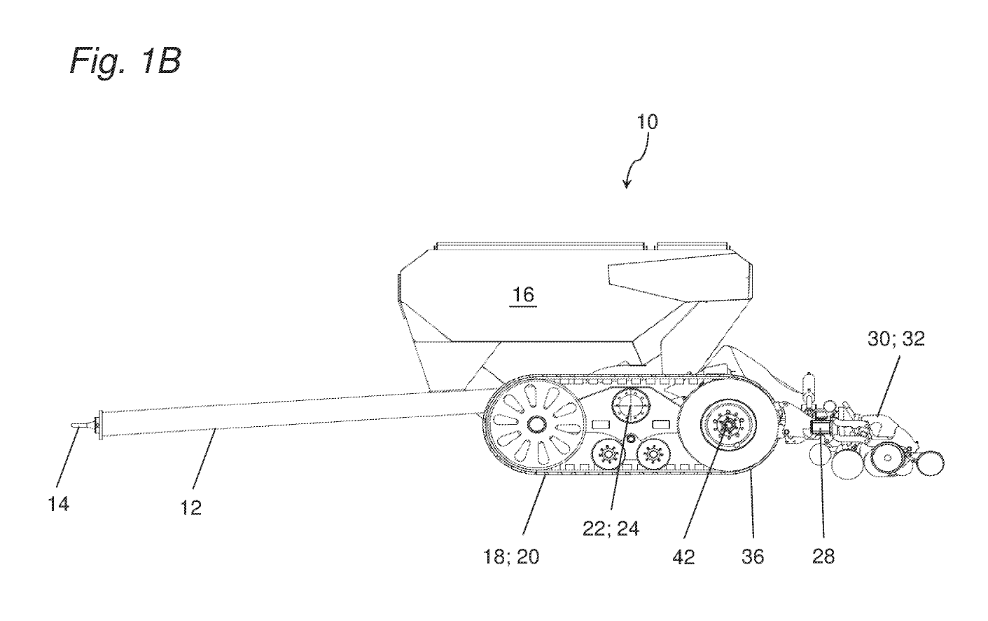

Identical reference numbers are used in FIGS. 1 to 3D for identical or equivalent elements of the invention. Furthermore, for a better overview, only the reference numbers necessary for the description of the respective figure are displayed in the individual figures. The embodiments shown are only examples of how the towed agricultural implement can be designed according to the invention and do not represent a final limitation.

One embodiment of a towed agricultural implement 10 is shown in FIGS. 1A and 1B. The implement 10 comprises a central frame 12 on which a connecting device 14 in the form of a drawbar eye for connecting the implement 10 to a towing vehicle not shown here is located in the front region. A hopper 16 is attached to the central frame 12 for storing and carrying spreading material to be distributed, e.g. seeds, fertilizer or the like. In addition to the central frame 12, guide elements 18, which roll on arable land, are mounted on the left and right, whereby the guide elements 18 in the embodiment of FIG. 1 are designed as a crawler track 20. In addition, each guide element 18 is mounted on the central frame 12 by means of a bearing 24 having a first axis of rotation 22, whereby the guide element 18 can pivotably be arranged around this bearing 24 in order to obtain improved ground hugging.

In addition, pivotable side frames 28 extend laterally on the central frame 12 around at least largely parallel axes 26 to the direction of travel, on which a plurality of work tools 30 are arranged at regular distances from one another, which work tools 30 are designed, for example, as sowing coulters 32. It should be noted that the side frames 28 are not directly connected to the central frame 12 but that an additional swivel frame is mounted between them, whereby this swivel frame could also be dispensed with so that there is a direct connection between the side frames 28 and the central frame 12.

In addition, a height-adjustable depth guide wheel 36 for guiding the side frames 28 and/or the working tools 30 along an area of arable land is connected to each side frame 28 by means of a cylinder 34.

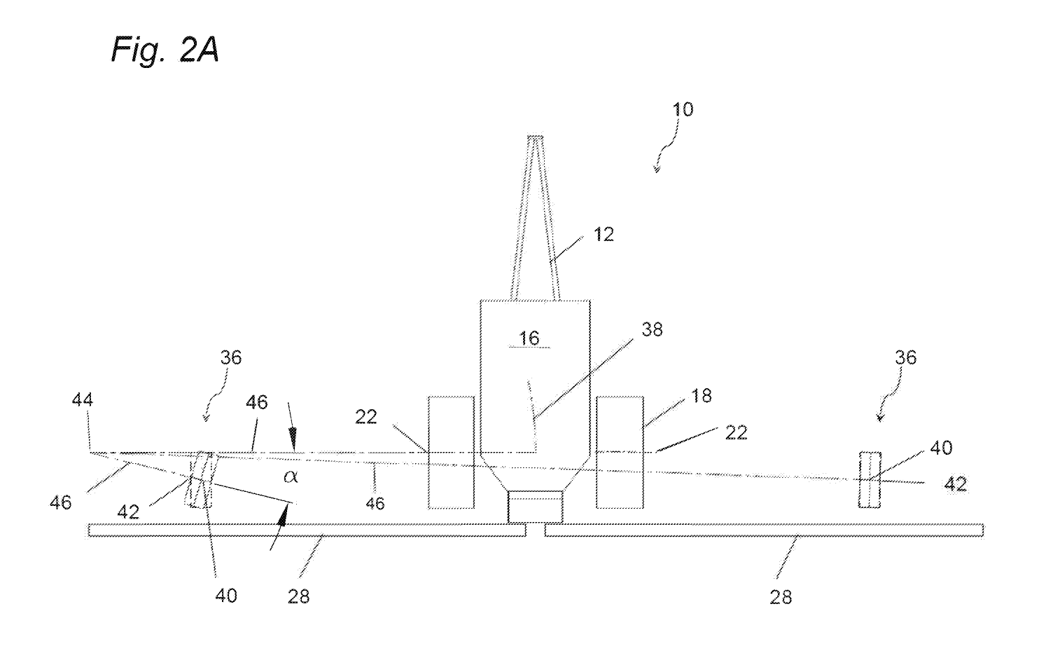

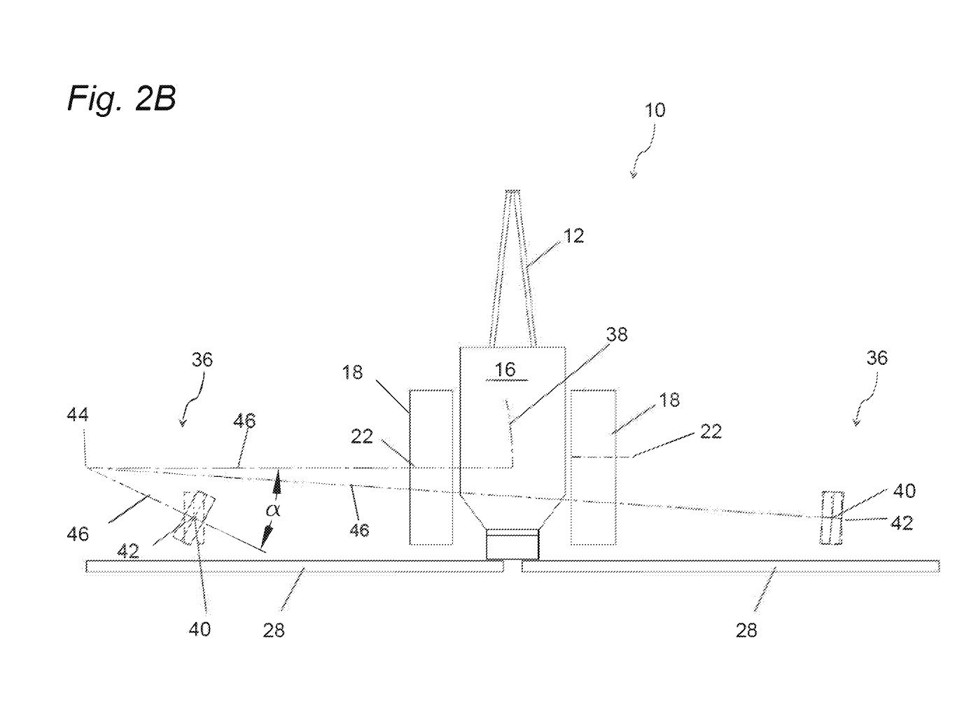

The respective functional relationships of the invention can again be seen in the schematic top views of FIGS. 2A and 2B. They each show different embodiments of implements 10, whereby the guide elements 18 of which have different lengths. Curve 38 in each view represents a curved path of travel of the implement 10. The first axis of rotation 22 of the guide elements 18 is located in the center of each guide element. The curve 38 indicates a left-hand curve, i.e. the implement 10 is moved counter-clockwise in each of the examples shown. Side frames 28 extend to the left and right of the central frame 12, whereby a depth guide wheel 36, which is pivotably arranged about an upright pivot axis 40, is connected to each of the side frames 28. In addition, the depth guide wheels 36 are pivotably mounted about second axes of rotation 42. To determine the respective swivel angles α of the depth guide wheels 36, radius lines 46 are drawn in each case from the center 44 of the curve 38 to the center of the pivot axes 40, whereby the orientation of the depth guide wheels 36 is in each case largely perpendicular to these lines during cornering. The depth guide wheels are shown with interrupted lines on the one hand and with continuous lines on the other, whereby the interrupted lines represent a straight or reverse travel, and whereby the continuous lines represent cornering in each case. In addition, the swivel angle inside the bend is always greater than the one outside.

With reference to FIG. 2A, the following dimensions or swivel angles α of the depth guide wheels may therefore occur during cornering, for instance. First, the first axis of rotation 22 and the second axis of rotation 42, for example, have an axial offset of 600 mm. In addition, the implement 10 has a working width of 18 meters, for example. With regard to a radius of 9 meters for curve 38 and an axial offset of 600 mm, the depth guide wheel 36 in the top view of FIG. 2A on the left therefore has a swivel angle α of 15° compared to a straight travel, whereas the depth guide wheel 36 located on the right in the top view of FIG. 2A has a swivel angle α of 2° compared to a straight travel.

In contrast, an axial offset of the first axis of rotation 22 from the second axis of rotation 42 of 1150 mm, for example, with the same working width of 18 meters and an identical radius of 9 meters for curve 38 for the depth guide wheel 36 located on the left in the top view of FIG. 2B, results in a swivel angle α of 27° compared to a straight travel, whereas the depth guide wheel 36 located on the right in the top view of FIG. 2A has a swivel angle α of 4° compared to a straight travel. This again shows that, aside from the radius of curve 38, the swivel angle α depends in addition on the respective offset between the first axis of rotation 22 of the guide element 18 and the second axis of rotation 42 of the depth guide wheels 36.

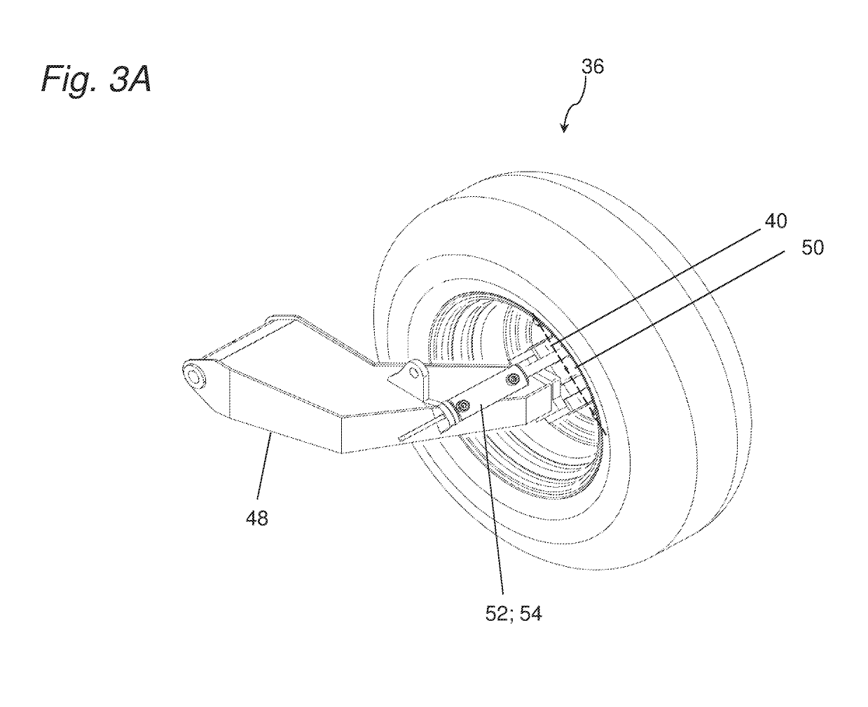

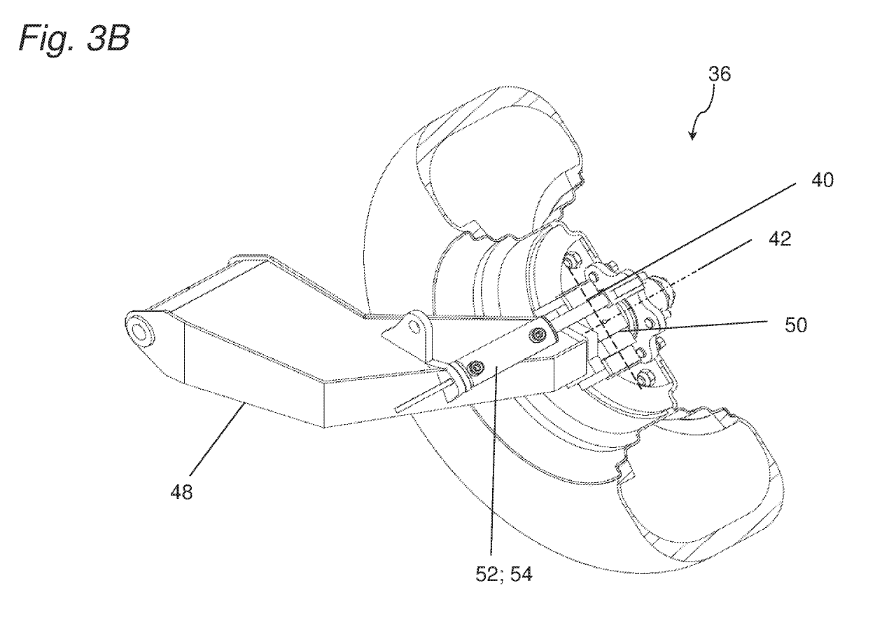

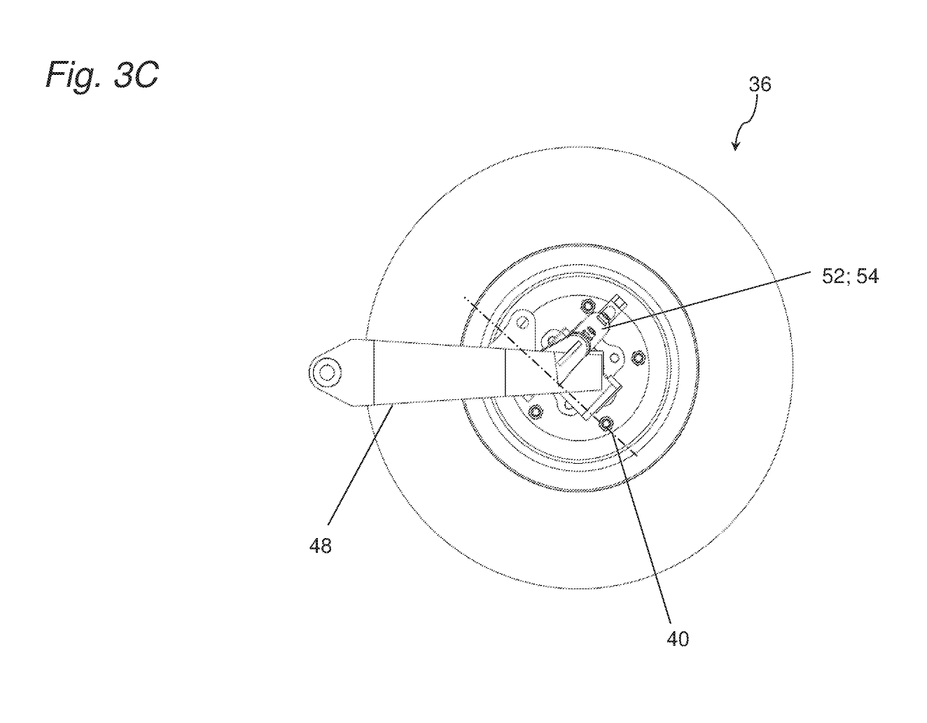

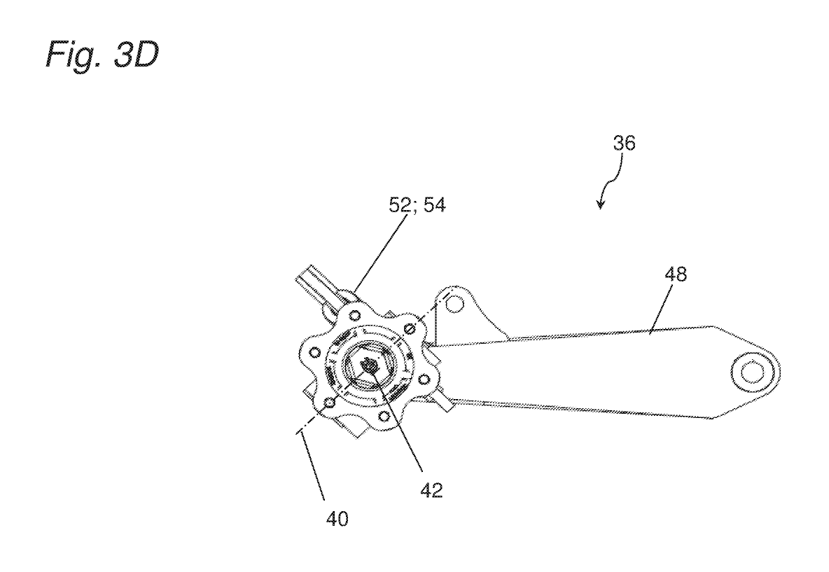

An embodiment of a depth guide wheel 36 and its suspension support 48 are shown in FIGS. 3A-3D. The depth guide wheels 36 are each pivotably mounted on a swiveling holder 50, whereby the pivot axis 40 of the swiveling holder 50 is oriented from the rear-top to front-bottom and, for example, has an angle of 30° relative to vertical. In addition, an adjacent arrangement of the second axis of rotation 42 of the depth guide wheels 36 in relation to the pivot axis 40 is provided in order not to change the working depth by a pivoting movement of the depth guide wheels 36 on the one hand and, on the other hand, to achieve the smoothest possible running. Here the second axis of rotation 42 and the pivot axis 40 in the embodiment of FIG. 3 (see FIG. 3B and FIG. 3D) intersect in each case.

In order not to obtain a transverse position of the depth guide wheels 36 either during forward travel or reverse travel, it is also provided that the depth guide wheels 36, which can be pivoted about an upright pivot axis 40, can be freely pivoted during forward travel of the implement 10 and that the depth guide wheels 36, which can be pivoted about an upright pivot axis 40, are brought into an at least largely parallel alignment to the at least one guide element 18 during reverse travel by means of a limiting element 52.

In order to obtain a simple embodiment of the limiting element 52, it is designed as an actuator 54, e.g. in the form of a linear drive. The actuator 54 is in particular an electrically, pneumatically or hydraulically operated actuator 54. According to a highlighted embodiment, the actuator 54 can be a hydraulically operated actuator 54, which can be controlled via an electrically controllable hydraulic valve. The hydraulic valve can be a conventional solenoid valve, for example.

The limiting element 52 can be designed as either an actuator 54 that can move freely in two directions and as an actuator 54 that can be locked in two directions, e.g. as a double-acting cylinder. Depending on the respective radius of curve 38 and/or the respective swivel angle α during a reverse drive, the respective side or the respective swivel range of the depth guide wheels 36 could be limited by this actuator 54 (and/or the double-acting cylinder) and the actuator 54 could also bring the depth guide wheel 36 into an at least approximately parallel alignment with respect to the guide element 18.

The invention was described with reference to a preferred embodiment. However, it is conceivable for an expert that modifications or variations of the invention can be made without departing from the scope of the claims below.

### LIST OF REFERENCE SIGNS

10 Implement
12 Central frame
14 Connecting device
16 Hopper
18 Guide element
20 Crawler track
22 First axis of rotation
24 Bearing
26 Axis
28 Side frame
30 Work tool
32 Sowing coulter
34 Cylinder
36 Depth guide wheel
38 Curve radius
40 Pivot axis
42 Second axis of rotation
44 Center
46 Line
48 Suspension support
50 Swiveling holder
52 Limiting element
54 Actuator
α Swivel angle

1. A towed agricultural implement comprising a central frame with a connecting device wherein side frames are arranged laterally to the central frame, which side frames can be pivoted around axes running parallel to the direction of travel and/or obliquely in space, wherein at least one guide element rolling on arable land is mounted on the central frame and/or next to the connecting device and at least one depth guide wheel rolling on arable land is mounted on each side frame, which depth guide wheels are pivotably mounted about an upright pivot axis with a swiveling holder, wherein the depth guide wheels are mounted on the swiveling holder via bearings having a second axis of rotation and the second axis of rotation of the depth guide wheels lies in the plane or adjacent to the plane of the pivot axis, and wherein the at least one guide element is mounted on the central frame with a bearing having a first axis of rotation, wherein the first axis of rotation and the second horizontal axis of rotation are axially offset relative to one another, characterized in that the depth guide wheels, which can be pivoted about an upright pivot axis, are freely pivotable during a forward travel of the implement and in that the depth guide wheels, which can be pivoted about an upright pivot axis, are brought into an at least largely parallel alignment to the at least one guide element during a reverse travel by means of a limiting element.

2. The implement as recited in claim 1 wherein the upright pivot axis of the depth guide wheels is aligned from rear-top to front-down and/or that the pivot axis of the depth guide wheels is inclined relative to a vertical axis, wherein this inclination is in particular between 15° and 75°.

3. The implement as recited in claim 1 wherein the swivel angle α of the depth guide wheels, which can be pivoted about an upright pivot axis during a forward travel of the implement is limited at least in one direction of rotation wherein the greater the offset of the first horizontal axis of rotation from the second horizontal axis of rotation is, the greater the swivel angle α is.

4. The implement as in claim 1 wherein the limiting element is designed as a linear drive.

5. The implement as in claim 1 wherein at least one guide element is designed as a crawler track.

6. The implement as in claim 1 wherein the depth guide wheels have an adjustable height.

7. The implement as in claim 1 wherein a linear drive and/or a spindle drive is associated with the swiveling holder of the depth guide wheels.

8. The implement as in claim 1 wherein a sensor operably detecting forward travel or reverse travel is attached to the implement and the limiting element is controllable on the basis of the detected forward travel or reverse travel.

9. The implement as in claim 1 wherein at least one guide element is mounted on the central frame pivotably about an upright pivot axis wherein the at least one guide element and the depth guide wheels have different swivel angles α during cornering.

10. The implement as in claim 1 wherein the first axis of rotation and the second axis of rotation have a horizontal orientation oriented transversely to the direction of travel or that these are oriented transversely to the direction of travel or that these have an orientation oriented obliquely in space and transversely to the direction of travel.

11. A towed agricultural implement comprising a central frame to which laterally extending side frames are pivotally connected, wherein at least one rolling support which rotates about a first axis of rotation is connected to and supports the central frame above the ground and at least one depth guide wheel is connected to each side frame and supports the respective side frame above the ground, each depth guide wheel connected to a respective side frame is pivotably mounted about an upright pivot axis by a swiveling holder and the respective depth guide wheel is rotatably mounted on the swiveling holder to rotate about a second axis of rotation which lies in a plane or adjacent to the plane of the upright pivot axis and wherein the first axis of rotation and the second axis of rotation are axially offset relative to one another, the towed agricultural implement further comprising a limiting element selectively engaging the swiveling holder of each depth guide wheel connected to a respective side frame when the respective depth guide wheel is moving in a reverse direction to maintain the respective depth guide wheel in approximately parallel alignment relative to the at least one rolling support and selectively disengaging the swiveling holder of each depth guide wheel connected to the respective side frame when the respective depth guide wheel is moving in a forward direction such that the respective depth guide wheel is freely pivotable during travel of the respective depth guide wheel in a forward direction.

12. The implement as in claim 11 wherein each of the limiting elements comprises a linear actuator.

13. The implement as in claim 11 further comprising a sensor associated with each of the depth guide wheels, each of said sensors operable to determine when the associated depth guide wheel moves in a forward or reverse direction and a controller causing the limiting element associated with a respective depth guide wheel to engage the respective swiveling holder when the associated sensor detects rearward movement of the respective depth guide wheel and to disengage the respective swiveling holder when the associated sensor detects forward movement of the respective depth guide wheel.
